(19) United States
(12) Patent Application Publication
(10) Pub. No.: US 2012/0050336 A1
(43) Pub. Date: Mar. 1, 2012

(54) TOUCH-BASED REMOTE CONTROL

(75) Inventors: Itay Nave, Kfar Hess (IL); Haggai David, Petach-Tikva (IL)

(73) Assignee: EXENT TECHNOLOGIES, LTD., Petach-Tikva (IL)

(21) Appl. No.: 13/220,950

(22) Filed: Aug. 30, 2011

Related U.S. Application Data
(60) Provisional application No. 61/379,288, filed on Sep. 1, 2010.

(51) Int. Cl. G06F 3/041; G09G 5/00

(52) U.S. Cl. 345/667; 345/173

(57) ABSTRACT

Systems and method for remotely controlling applications executing on display devices that do not have touch-based user input capabilities even when such applications were programmed to rely exclusively on touch-based control are described. In accordance with certain embodiments, user input events produced when a user interacts with a touch-based user input component of a remote control device are captured and transmitted to a display device that is executing a target application. On the display device, software components that are not part of the original source code of the target application convert the received user input events into commands that are recognizable to the target application and inject those commands into the target application. The software components also cause a visually-perceptible hotspot indicator to be overlaid on graphical content rendered to a display of the display device by the target application, thereby facilitating targeted control of the application by the user.

### CROSS-REFERENCE TO RELATED APPLICATIONS

This application claims priority to U.S. Provisional Patent Application No. 61/379,288, filed Sep. 1, 2010, the entirety of which is incorporated by reference herein.

### BACKGROUND OF THE INVENTION

1. Field of the Invention

The present invention generally relates to systems and methods for remotely controlling a display device such as a television. In particular, the present invention relates to systems and methods for remotely controlling an application executing on display device using a touch-based remote control.

2. Background

Many electronic devices that include touch-based user input capabilities have been introduced into the marketplace. For example, a large number of conventional mobile devices such as cellular telephones, tablet computers, and netbooks include touch screens that provide touch-based user input capabilities. Unlike traditional desktop computers, many of these mobile devices do not include a physical keyboard or a mouse for enabling a user to interact with an application running on the device. Consequently, applications that run on these devices must be programmed to rely exclusively on touch-based user input for control.

Recently, there have been efforts to extend the use of operating systems designed for mobile devices to televisions. For example, GOOGLE TV™ is a product/service implemented on a television that will utilize the ANDROID™ operating system, which was developed for mobile devices. It is anticipated that other products/services to be developed for televisions will attempt to exploit operating systems designed for mobile devices. One problem associated with this trend is that many native applications that were developed to execute on a mobile device operating system have not been developed with control capabilities that are useful in a television environment.

When executing an application on a mobile device that includes a touch screen, user control is achieved via a user's touch. This form of user control assumes that the user is currently looking at the screen and can point with his finger at a desired spot on the screen. For example, FIG. 1 depicts an example mobile device 100 that is executing an application that is controlled by touch. As shown in FIG. 1, the application displays a button 104 for initiating a sign-in process at a certain position on a touch screen display 102 of mobile device 100. In order to activate the button, a user must first look at touch screen display 102 to identify where button 104 is located and then use his/her fingertip to apply pressure to touch screen display 102 at the identified location. This process is illustrated in FIG. 2, which shows that an eye 202 of the user is directed at touch screen display 102 so that the user can locate and touch button 104 with his finger 204.

A problem arises when trying to run applications developed for touch-based mobile devices on a television. This is because most televisions do not provide touch screen capabilities. Furthermore, even if a television did provide touch screen capabilities, many viewers prefer to view television from a distance, making interaction with the television screen impracticable. Thus, the user cannot tap the television screen.

In addition to the “tap” functionality described above, many touch-based mobile devices also provide “drag” functionality. “Drag” functionality is typically invoked by sliding a finger across the surface of a touch screen. When this occurs, a scroll command is issued to an application running on the mobile device. The scroll command causes the application to scroll the currently-displayed content in the direction of the finger stroke. Furthermore, touch-based mobile devices that support multi-touch allow a user to interact with the touch screen using two fingers at the same time. For example, by touching the touch screen with two fingers and then increasing the distance between the fingers, a “zoom in” command can be conveyed to an application running on the touch-based mobile device. Conversely, by touching the screen with two fingers and then reducing the distance between the fingers, a “zoom out” command can be conveyed to the application.

When products such as GOOGLE TV™ are made available, they will be capable of running applications that were developed for a mobile device operating system (such as ANDROID™). The problem, however, is how to control the application. As noted above, most televisions do not have any touch-based user input capabilities and it is also not practical to control a television by touching the television screen. Standard controllers such as keyboards and mice cannot help as many applications already available have not been built to support keyboard or mouse control.

Thus, there exists a need to provide a control interface for remotely-viewed display devices, such as televisions, that use the same operating system as touch-based mobile devices and that are capable of executing applications that were developed for execution on such touch-based mobile devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

Embodiments described herein provide a system and method for remotely controlling applications executing on display devices that do not have touch-based user input capabilities, such as televisions, even when such applications were programmed to rely exclusively on touch-based control. In accordance with various embodiments described herein, user input events produced when a user interacts with a touch-based user input component of a remote control device are captured and transmitted to a display device that is executing a target application. On the display device, software components that are not part of the original source code of the target application operate to convert the received user input events into commands (e.g., “tap,” “drag,” or “zoom”) that are recognizable to the target application and inject those commands into the target application. The software components also cause a visually-perceptible hotspot indicator to be overlaid on graphical content rendered to a display of the display device by the target application, thereby allowing the user to determine how his interactions with the touch-based user input component of the remote control device will correspond to graphical elements currently being shown on the display of the display device.

In particular, a method for remotely controlling a target application executing on a display device is described herein, wherein the target application is configured to perform operations in response to a predefined set of commands and wherein at least one of the operations comprises rendering graphical content to a display of the display device. In accordance with the method, user input events generated in response to interaction by a user with a touch-based user input component of a remote control device are received. The user input events are converted into commands from the predefined set of commands. The commands are then injected into the target application executing on the display device, thereby causing the target application to perform operations corresponding to the injected commands. In accordance with the foregoing method, the injecting step is performed by a processing unit of the display device responsive to executing code that is not part of original source code associated with the target application.

Depending upon the implementation of the foregoing method, the converting step may be performed by the remote control device, the display device or by a third device that is not the remote control device or the display device.

In accordance with an embodiment, the foregoing method further includes identifying a location of a hotspot on the display of the display device and providing a visual indication of the hotspot location on the display. In further accordance with such an embodiment, converting the user input events into commands may include converting one or more of the user input events into a tap command at the hotspot location, converting one or more of the user input events into a drag command that is initiated at the hotspot location, or converting the user input events into a zoom command.

A system is also described herein. The system includes a display device and a remote control device. The display device includes a first processing unit and a display. The first processing unit is operable to execute a target application that performs operations in response to a predefined set of commands, wherein at least one of the operations comprises rendering graphical content to the display. The remote control device includes a second processing unit and a touch-based user input component. The second processing unit is operable to execute remote control logic that captures user input events generated when a user interacts with the touch-based user input component and transmits the user input events to the display device via a network. The first processing unit of the display device is further operable to execute controller logic and injection logic that are not part of original source code of the target application. The controller logic generates commands from the predefined set of commands based on the user input events received from the remote control device and the injection logic injects the commands generated by the controller logic into the target application, thereby enabling the user to remotely control the performance of the operations of the target application.

In one implementation of the system, the controller logic identifies a location of a hotspot on the display of the display device and the first processing unit of the display device is further operable to execute overlay logic that provides a visual indication of the hotspot location on the display. In further accordance with such an embodiment, the controller logic generates a tap command at the hotspot location or a drag command that is initiated at the hotspot location based on the user input events received from the remote control device. The drag command that is generated may be one of two drag commands that together comprise a zoom command.

In a further implementation of the system, the display device does not include a touch-based user input component but the target application is configured to perform the operations in response to commands generated based on user interaction with a touch-based user input component.

A computer program product is also described herein. The computer program product comprises a computer-readable storage medium having computer program logic recorded thereon for enabling a processing unit to facilitate remote control of a target application executing on a display device of which the processing unit is a part. The target application is configured to perform operations in response to a predefined set of commands, wherein at least one of the operations comprises rendering graphical content to a display of the display device. The computer program logic includes first computer program logic, second computer program logic and third computer program logic. The first computer program logic, when executed by the processing unit, receives user input events generated in response to interaction by a user with a touch-based user input component of a remote control device. The second computer program logic, when executed by the processing unit, converts the user input events into commands from the predefined set of commands. The third computer program logic, when executed by the processing unit, injects the commands into the target application executing on the display device, thereby causing the target application to perform operations corresponding to the injected commands. The aforementioned first, second and third computer program logic are not part of original source code associated with the target application.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 depicts a conventional mobile device executing an application that is programmed to be controlled by touch-screen-based input.

FIG. 2 illustrates touch-screen-based activation of a button displayed by the application executing on the mobile device of FIG. 1.

FIG. 3 is a block diagram of an example system that facilitates touch-based remote control of a target application executing on a display device in accordance with an embodiment.

FIG. 4 depicts a flowchart of a method for implementing touch-based remote control of a target application executing on display device in accordance with one embodiment in which a conversion function is performed by the display device.

FIG. 5 depicts a flowchart of a method for implementing touch-based remote control of a target application executing on display device in accordance with an alternate embodiment in which the conversion function is performed by a remote control device.

FIG. 6 depicts a flowchart a method by which a system in accordance with an embodiment utilizes a visually-perceptible indictor of a hotspot location on a display of a display device 304 to facilitate touch-based remote control.

FIG. 7 depicts a flowchart of a method by which a user may interact with a touch-based user interface component of a remote control device to change a location of a hotspot on a display of a display device in accordance with an embodiment.

FIG. 8 illustrates a touch-based user interface component in accordance with an embodiment that includes a hotspot control area that encompasses an entire pad or screen thereof.

FIG. 9 illustrates a touch-based user interface component in accordance with an alternate embodiment that includes a hotspot control area, a tap area and a drag area.

FIG. 10 is a block diagram of a processor-based computing system that may be used to implement a display device and/or a remote control device in accordance with an embodiment.

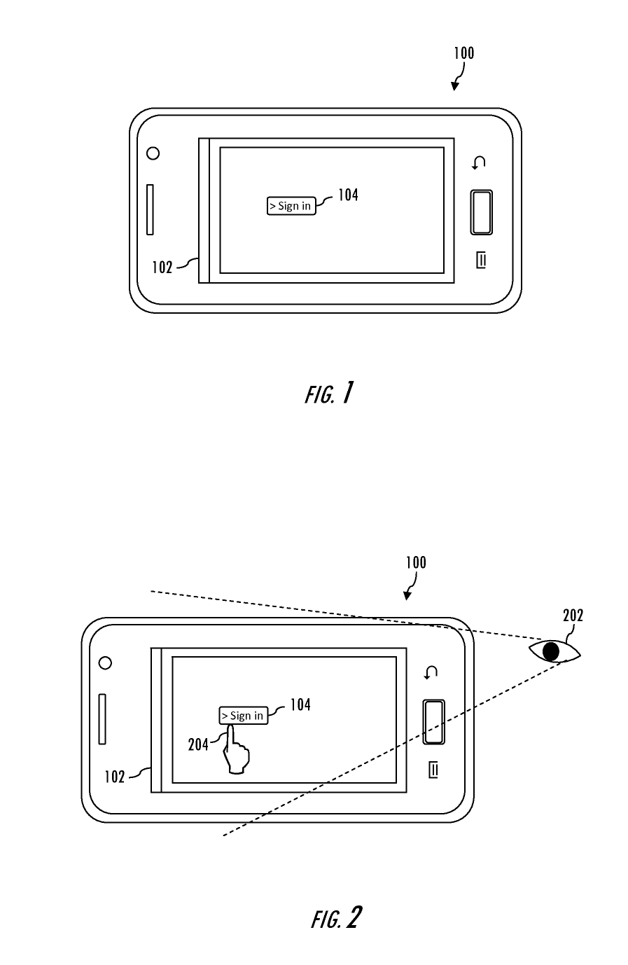

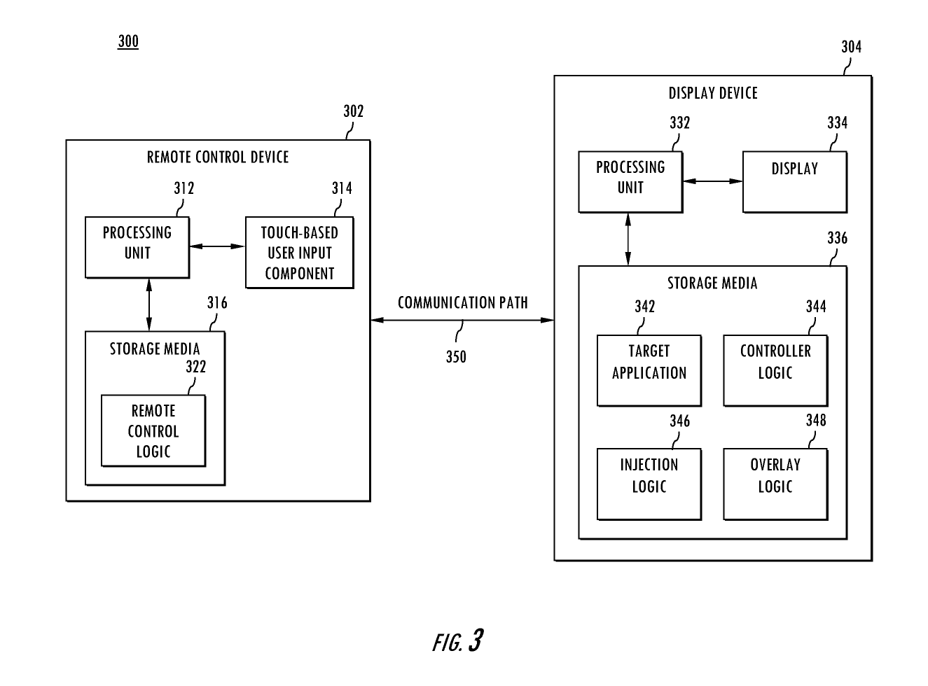

The features and advantages of the present invention will become more apparent from the detailed description set forth below when taken in conjunction with the drawings.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Embodiments described herein provide a system and method for remotely controlling applications executing on display devices that do not have touch-based user input capabilities, such as televisions, even when such applications were programmed to rely exclusively on touch-based control. In accordance with various embodiments described herein, user input events produced when a user interacts with a touch-based user input component of a remote control device are captured and transmitted to a display device that is executing a target application. On the display device, software components that are not part of the original source code of the target application operate to convert the received user input events into commands (e.g., “tap,” “drag,” or “zoom”) that are recognizable to the target application and inject those commands into the target application. In alternate embodiments, the conversion is performed on the remote control device or a third device that is not the display device or the remote control device. The software components on the display device also cause a visually-perceptible hotspot indicator to be overlaid on graphical content rendered to a display of the display device by the target application, thereby allowing the user to determine how his interactions with the touch-based user input component of the remote control device will correspond to graphical elements currently being shown on the display of the display device.

### II. Example System and Method for Touch-Based Remote Control of Target Application Executing on Display Device

FIG. 3 is a block diagram of an example system 300 that facilitates touch-based remote control of a target application executing on a display device in accordance with an embodiment. As shown in FIG. 3, system 300 includes a display device 304 and a remote control device 302 that is communicatively connected thereto via a communication link 350.

In an embodiment, display device 304 comprises a television. However, this example is not intended to be limiting, and display device 304 may comprise any device or system that includes a display and is capable of executing applications that render graphical content thereto. For example display device 304 may also comprise a television and associated set top box, a desktop computer and associated display, a laptop computer, a tablet computer, a video game console and associated display, a portable video game player, a smart telephone, a personal media player or the like. In a particular embodiment, display device 304 does not include a touch-based user interface component and thus cannot itself generate touch-based user input.

Remote control device 302 comprises a device that is configured to interact with display device 304 via communication link 350. As shown in FIG. 3, remote control device 302 includes a touch-based user input component 314 with which a user may interact to provide input to remote control device 302. The touch-based user input component 314 may comprise, for example and without limitation, a touch pad or a touch screen. In one embodiment, remote control device comprises a smart phone with touch screen capabilities. However, this example is not intended to be limiting and remote control device 302 may comprise other devices that include touch-based user input components.

Communication path 350 is intended to generally represent any path by which remote control device 302 may communicate with display device 304. Communication path 350 may include one or more wired or wireless links. For example, communication path 350 may include a wireless link that is established using infrared (IR) or radio frequency (RF) communication protocols, although this is only an example. In certain implementations, communication link 350 includes one or more network connections. For example, remote control device 302 may be connected to display device 304 via a wide area network (WAN) such as the Internet, a local area network (LAN), or even a personal area network (PAN). Such networks may be implemented using wired communication links (e.g., Ethernet) and/or wireless communication links (e.g., WiFi or BLUETOOH®) as is known in the art.

As further shown in FIG. 3, display device 304 includes a processing unit 332, a display 334, and storage media 336. Processing unit 332 is connected to storage media 336 and is operable to execute software modules stored thereon in a well-known manner. Processing unit 332 is also connected to display 334 and is operable to render graphical content thereto in a well-known manner. In certain embodiments, processing unit 332 comprises one or more microprocessors or microprocessor cores, although this is only an example. Storage media 336 may include one or more of volatile and nonvolatile, removable and non-removable media implemented in any method or technology for storage of information such as computer-readable instructions, data structures, software modules or other data. Storage media 336 may include, but is not limited to, one or more of RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store desired information and which can accessed by processing unit 332.

Storage media 336 is shown as storing a target application 342. Target application 342 is a computer program that is configured to perform operations on behalf of a user when executed by processing unit 332. By way of example and without limitation, target application 342 may comprise an application that allows a user to play a video game, send and receive e-mails or instant messages, browse the Web, maintain a calendar or contact list, obtain weather information, obtain location information and maps, obtain and play video and/or audio content, create and review documents, or the like. To expose such functionality to a user, target application 342 is configured to render graphical content to display 334 and to accept user input from a touch-based user interface component such as a touch screen. In some implementations, target application 342 may be programmed to exclusively rely on touch-based user input for user control. As noted above, however, display device 334 may not include a touch-based user interface component.

To extend the functionality of display device 304 so that applications executing thereon can be controlled by touch-based user input received by remote control device 302, three additional software modules are also stored by storage media 336 and executed by processing unit 332: controller logic 344, injection logic 346 and overlay logic 348. In one embodiment, controller logic 344 is loaded onto display device 304 and then loads injection logic 346 and overlay logic 348 as required. Such software modules may execute as services on display device 304 or can be injected into target application 342 using various methods. However, in either case, such software modules may exist apart from the compiled code of target applications 342. The manner in which these software modules operate will be described below.

As also shown in FIG. 3, remote control device 302 includes a processing unit 312, touch-based user input component 314 and storage media 316. Processing unit 312 is connected to storage media 316 and is operable to execute software modules stored thereon in a well-known manner. Processing unit 312 is also connected to touch-based user input component 314 and is operable to generate user input events in response to user interaction therewith. Like processing unit 332 of display device 304, processing unit 332 may comprise one or more microprocessors or microprocessor cores, although this is only an example. Storage media 316 may comprise one or more of any of the various types of memories and storage devices described above in reference to storage media 336 of display device 304.

Storage media 316 is shown as storing remote control logic 322. Remote control logic 322 is configured to capture user input events that are generated in response to user interaction with touch-based user input component 314 when executed by processing unit 332. Other functions and features of remote control logic 322 will be described below.

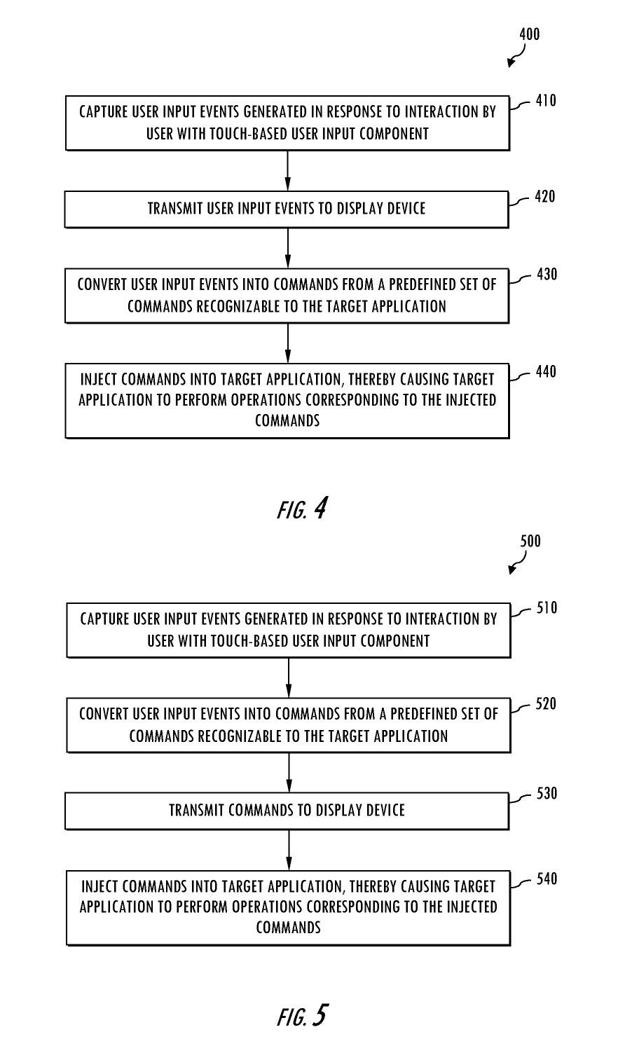

FIG. 4 depicts a flowchart 400 of one method by which system 300 may implement touch-based remote control of target application 342 executing on display device 304. Although the steps of flowchart 400 will now be described as being performed by components of system 300, persons skilled in the relevant art(s) will appreciate that the steps may be performed by other components or systems entirely. Consequently, although continued reference is made to system 300 of FIG. 3, such reference is not intended to be limiting.

Additionally, in the following, where a software module is described as performing a certain operation, it is to be understood that such operation is performed when the software module is executed by a processing unit (e.g., when remote control logic 322 is executed by processing unit 312, or when any of target application 342, controller logic 344, injection logic 346 or overlay logic 348 is executed by processing unit 332).

As shown in FIG. 4, the method of flowchart 400 begins at step 410, in which remote control logic 322 captures user input events that are generated in response to interaction by a user with touch-based user input component 314. Such user interaction may comprise, for example, the user tapping, pressing, or moving a finger or stylus across or above a surface of touch-based user input component 314. If the touch-based user input component 314 provides multi-touch capability, then such user interaction may comprise the user touching the surface of touch-based user input component 314 with multiple fingers simultaneously.

At step 420, remote control logic 322 causes the captured user input events to be transmitted to controller logic 344 executing on display device 304 via communication path 350. Any suitable communication protocol may be used to enable such transmission. In one embodiment, the communication protocol is initiated by remote control logic 322 when the execution of remote control logic 322 is initiated on remote control device 302.

At step 430, controller logic 344 converts the user input events received from remote control logic 322 into one of a predefined set of commands that will be recognizable to target application 342 and provides the commands to injection logic 346. As will be discussed below, such commands may include tap commands, drag commands, zoom in commands, or zoom out commands. However, these examples are not intended to be limiting and numerous other commands may be utilized in accordance with the various control capabilities of target application 342.

At step 440, injection logic 346 injects the commands generated during step 430 into target application 342, thereby causing target application 342 to perform operations corresponding to the injected commands. For example, injection logic 346 may inject tap, drag, zoom in or zoom out commands generated during step 430 into target application 342 and target application 342 may perform operations in accordance with such commands. As will be discussed below, the injection of the commands into target application 342 may be carried out in one embodiment by hooking functions of target application 342, although this is only one approach.

In accordance with the foregoing method of flowchart 400, the step of converting the user input events captured by remote control logic 322 into commands that will be recognizable to target application 430 is performed by controller logic 344 installed on display device 304. However, in an alternate embodiment, such conversion step may instead be performed by remote control logic 322 itself FIG. 5 depicts a flowchart 500 of a method for implementing touch-based remote control in accordance with such an alternate embodiment. Like the method of flowchart 400, the method of flowchart 500 will be described in reference to system 300 but is not limited to that implementation.

As shown in FIG. 5, the method of flowchart 500 begins at step 510, in which remote control logic 322 captures user input events that are generated in response to interaction by a user with touch-based user input component 314. At step 520, remote control logic 322 converts the captured user input events into one of a predefined set of commands that will be recognizable to target application 342. At step 530, remote control logic 322 transmits the commands generated during step 520 to controller logic 344 executing on display device 304 via communication path 350 and controller logic 344 provides the commands to injection logic 346. At step 540, injection logic 346 injects the commands received during step 530 into target application 342, thereby causing target application 342 to perform operations corresponding to the injected commands.

In a still further embodiment, the step of converting the user input events captured by remote control logic 322 into commands that will be recognizable to target application 430 is performed by a third device that is not remote control device 302 or display device 304. For example, the third device may be an intermediate device that comprises a node along communication path 350. Such third device may receive user input events transmitted by remote control logic 322, convert the user input events into commands recognizable by target application 342, and then transmit the commands to controller logic 344.

In order to facilitate a user's ability to remotely control target application 342, an embodiment of system 300 causes a visually-perceptible indicator to be overlaid on graphical content rendered to display 334 by target application 342. The location of such visually-perceptible indicator on display 334 corresponds to a location of a point or area on display 334 at which a touch-based command will occur or be initiated. This point or area is referred to herein as a “hotspot.” Such visually-perceptible indicator of the hotspot location may comprise, for example, a pointer, cursor, cross-hair or the like. This enables the user to determine how his interaction with touch-based user input component 314 of remote control device 302 will correspond to graphical elements currently being shown on display 334 of display device 304. This is beneficial, for example, because it enables the user to target his interactions to certain ones of those graphical elements.

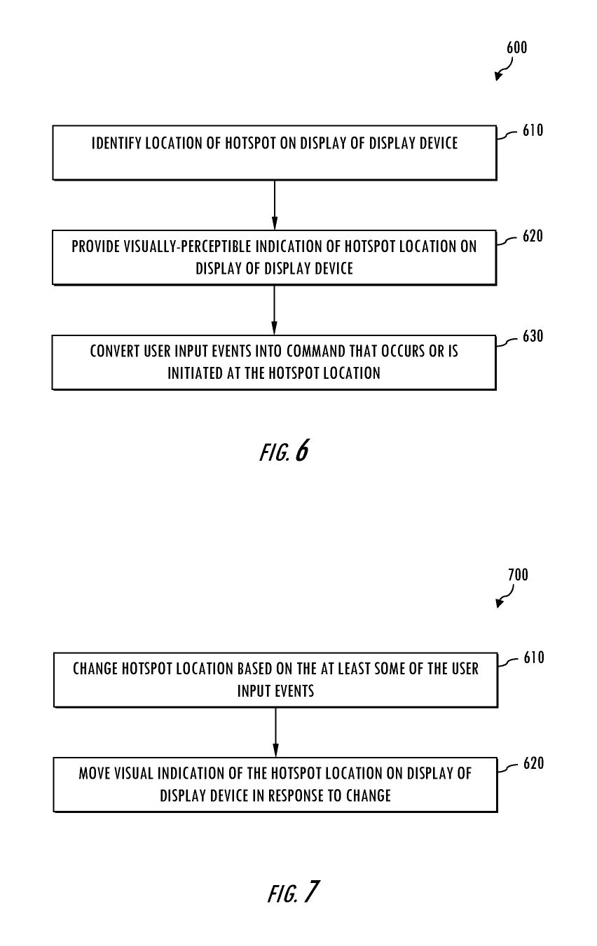

FIG. 6 depicts a flowchart 600 of a method by which system 300 may utilize such a visually-perceptible indictor of a hotspot location on display 334 of display device 304 to facilitate touch-based remote control. Like the methods of flowcharts 400 and 500, the method of flowchart 600 will be described in reference to system 300 but is not limited to that implementation.

As shown in FIG. 6, the method of flowchart 600 begins at step 610, in which controller logic 344 identifies a location of a hotspot on display 334 of display device 304. At step 620, controller logic 344 provides the identified hotspot location to overlay logic 348 which causes a visually-perceptible indication of the hotspot location to be rendered to display 334 of display device 304. For example, overlay logic 348 may cause a pointer, cursor, cross-hair or other visually-perceptible indicator to be rendered on top of graphic content currently being rendered to display 334 on behalf of target application 342. In accordance with one embodiment, overlay logic 348 performs this function by hooking graphics-related function calls issued by target application 342, although this is merely one approach.

At step 630, user input events captured by remote control logic 322 are converted into a command that occurs or is initiated at the hotspot location. For example, as will be discussed below, user input events captured by remote control logic 322 may be converted into a tap command that occurs at the hotspot location or a drag command that is initiated at the hotspot location although these are only a few examples. This conversion step may be performed, for example, by controller logic 344 of display device 304 in accordance with step 430 of flowchart 400 or by remote control logic 322 of remote control device 302 in accordance with step 520 of flowchart 500.

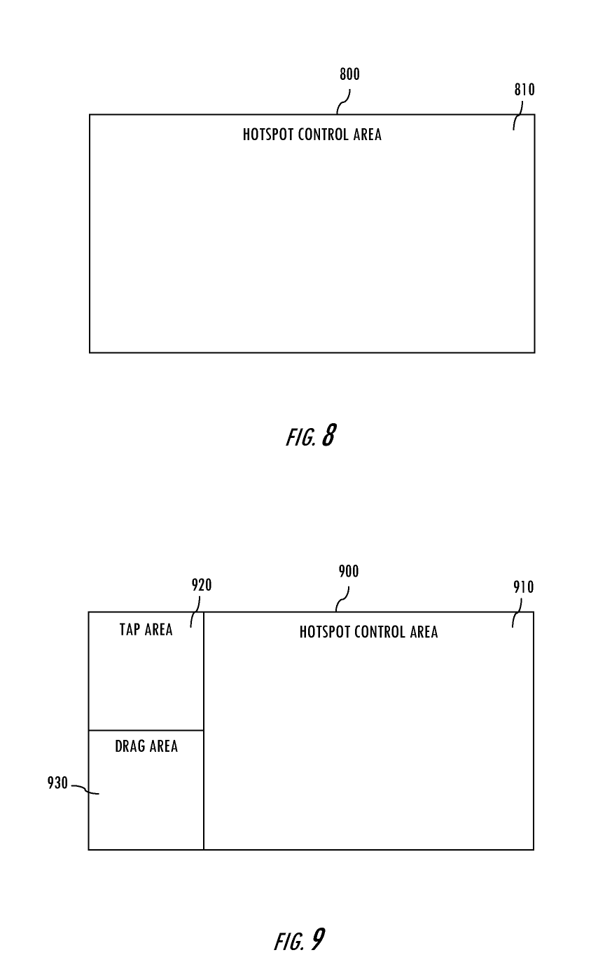

In accordance with an embodiment, the user may interact with touch-based user input component 314 to change the location of the hotspot on display 334 and overlay logic 348 may cause the location of the visually-perceptible indicator to be changed in a corresponding manner FIG. 7 depicts a flowchart 700 of a method by which this may occur. As shown in FIG. 7, the method begins at step 702 in which the hotspot location is changed based on at least some of the user input events captured by remote control logic 322. In one embodiment, this step is performed by controller logic 344 based on user input events and/or commands derived therefrom that are received from remote control logic 322. At step 704, the updated hotspot location is provided to overlay logic 346, which moves the visually-perceptible indication of the hotspot location on display 334 in response to the change.

In the following sub-sections II.A, II.B and II.C, various example methods will be described by which a user may interact with touch-based user input component 314 of remote control device 302 to manage the location of a hotspot on display 334 and to perform a tap, drag, or zoom in/zoom out in association with such hotspot. The various methods used will depend upon the particular implementation of system 300. The examples provided in the following sub-sections are not intended to be limiting and persons skilled in the relevant art(s) will appreciate that further methods for performing such operations can be conceived of.

A. Tap Functionality

The following describes example ways by which “tap” functionality can be implemented by system 300 in FIG. 3. Prior to initiating a tap command, the user may first want to select a hotspot location at which the tap command should occur. In one embodiment, the user achieves this by touching a surface of touch-based user input component 314 with one finger and moving that finger to change the location of the hotspot. Such interaction results in the generation of user input events. The user input events (or commands that are derived therefrom) are then transmitted to controller logic 344. In response to receiving this information, controller logic 344 modifies the location of the hotspot and causes overlay logic 348 to modify the location of the visually-perceptible indicator of the hotspot in a corresponding manner. As a result, the visually-perceptible indicator is moved to the new hotspot location.

Once the hotspot is situated at a desired screen location, the user may initiate a tap command at the hotspot location. The manner in which the user initiates the tap command may vary depending upon the implementation. In one embodiment, the user taps any position on a surface of touch-based user input component 314 with a second finger while the first finger (i.e., the finger that was used to select the hotspot location) continues to touch the surface of touch-based user input component 314. In accordance with such an embodiment, the user can easily move the hotspot location to a target position on display 334 using a first finger and then initiate a tap command at the target location using his second finger. In further accordance with such an embodiment, the entire surface of touch-based user input component 314 may be used as a hotspot control area. This is illustrated in FIG. 8, which shows a touch-based user interface component 800 that includes a hotspot control area 810 that encompasses an entire surface thereof.

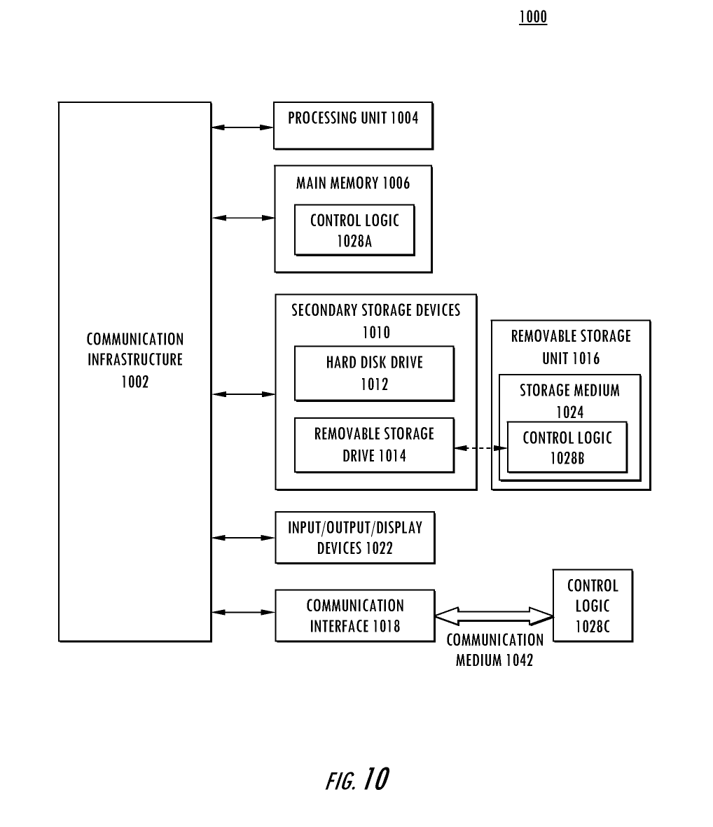

In an alternate embodiment, the user initiates the tap command at the hotspot location by tapping an area on the surface of touch-based user input component 314 dedicated to tap commands. By way of example, FIG. 9 shows a touch-based user interface component 900 that includes a hotspot control area 910, a tap area 920 and a drag area 930. In accordance with this example, the user interacts with hotspot control area 910 to move the hotspot to a desired location on display 334 (e.g., by moving his finger across the surface of hotspot control area 910). The user then taps tap area 920 to indicate that a tap command should occur at the current hotspot location.

In another embodiment, the user initiates the tap command by simply tapping anywhere on the surface of touch-based user input component 314. For example, it is possible to identify such interaction as representing a tap command by measuring an amount of time that passes from when the user's finger first touches the touch pad/touch screen to a time when the user's finger is removed and then comparing the measured time to a predetermined maximum time (e.g., 100 milliseconds). If the amount of time is less than the predetermined maximum time, then the interaction is determined to represent a tap command as opposed to some other command, such as a drag or move command.

In a further embodiment in which the ANDROID™ operating system is used, a tap event may be captured by using the function View.OnClickListener. Such function is documented at the ANDROID™ developer website. (http://developer.android.com/reference/android/view/View.OnClickListener.html).

When the user events that are determined to comprise a tap event are generated, those user events are converted into a tap command that occurs at the current hotspot location and provided to injection logic 346 which inserts such tap command into target application 342.

B. Drag Functionality

The following describes example ways by which “drag” functionality can be implemented by system 300 in FIG. 3.

In one embodiment, a user may use a first finger to move the hotspot to a desired location on display 334 in a manner similar to that described above in reference to tap functionality. Once the hotspot is situated at a desired screen location, the user may initiate a drag command at the hotspot location by pressing a second finger on the surface of touch-based user input component 314 and not removing it. While the second finger is so situated, any future move of the first finger will trigger drag commands. Such an implementation may be used, for example, in conjunction with touch-based user interface component 800 of FIG. 8.

In an alternate embodiment, a user initiates the drag command at the hotspot location by pressing an area on the surface of touch-based user input component 314 dedicated to drag commands. By way of example, continued reference is made to touch-based user interface component 900 of FIG. 9. In accordance with this example, the user interacts with hotspot control area 910 to move the hotspot to a desired location on display 334 (e.g., by moving a first finger across the surface of hotspot control area 910). The user then presses a second finger on drag area 930 to indicate that a drag command will be initiated. Then, the user moves the first finger across hotspot control area 910 to generate drag commands. Drag area 930 thus provides a state machine trigger that causes the system to inject drag commands into target application 342 in response to a user's interaction with hotspot control area 910 rather than generating commands to move the hotspot.

In a further embodiment in which the ANDROID™ operating system is used, a drag event may be captured by using the function View.OnDragListener. Such function is documented at the ANDROID™ developer website. (http://developer.android.com/reference/android/view/View.OnDragListener.html).

It is noted that alternate embodiments may use different combinations of state machines, finger combinations and areas on touch-based user input component 314 in order to move the hotspot and remotely control target application 334.

C. Scale (Zoom) Functionality

Zoom is typically implemented by applications that identify two drag operations being performed by two fingers at the same time. Zoom in is typically triggered by the fingers moving away from each other and zoom out is typically triggered when the two fingers are moved closer to each other.

One example of how a zoom operation may be implemented using touch-based user input component 800 of FIG. 8 will now be described. In accordance with this example, a user may use a first finger to move the hotspot to a desired location on display 334. Once the hotspot is situated at a desired screen location, the user may initiate a zoom command by pressing a second finger on the surface of touch-based user input component 800 and not removing it. While the second finger is so situated, the first finger and a third finger may be simultaneously moved across the surface of touch-based user input component 800 to initiate two drag commands that together comprise a zoom command. If the first and third fingers are moved towards each other, a zoom out command is initiated and if the first and third fingers are moved away from each other, a zoom in command is initiated.

An example of how a zoom operation may be implemented using touch-based user input component 900 of FIG. 9 will now be described. In accordance with this example, the user interacts with hotspot control area 910 to move the hotspot to a desired location on display 334 (e.g., by moving a first finger across the surface of hotspot control area 910). The user then presses one finger on drag area 930 and uses two other fingers in hotspot control area 910 to trigger a zoom in or zoom out operation (e.g., by placing such fingers on the surface of hotspot control are 910 and moving them apart or together). In this case, drag area 930 provides a state machine trigger that causes the system to inject zoom commands into target application 342 in response to a user's interaction with hotspot control area 910 rather than generating commands to move the hotspot.

Again, it is noted that alternate embodiments may use different combinations of state machines, finger combinations and areas on touch-based user input component 314 in order to move the hotspot and remotely control target application 334.

### III. Technical Details

Various technical details relating to specific implementations of system 300 will now be provided. By way of example, the following functionality may be implemented in a system in which display device 304 is executing the ANDROID™ operating system:

1. Remote control logic 322 uses Override Activity::dispatchTouchEvent(MotionEvent ev) to obtain all user input events and send them to display device 304.

2. Injection logic 346 uses the function Instrumentation::sendPointerSync(event) to inject the desired commands into target application 342.

3. In order to present an overlay cursor (or other visually-perceptible indicator of the hotspot) overlay logic 348 may use the following functionality:
a. Hook setContentView function. Obtain the view from the resource id using:
   i. LayoutInflater inflater=getLayoutInflater( );
   ii. View currView=(View)inflater.inflate(layoutResID, null);
b. On setContentView hook the main view is retrieved (could be view/layout)
c. Create a new FrameLayout class instance.
d. Create a new class overlay that extends the class View and implement in it the cursor drawing and an interface to receive drag and move commands
e. Push the overlay view to the top of new layout using AddView method.
f. Place the original view under the new overlay view using AddView method.
g. Draw a cursor image on the new overlay view based on a position received from remote control logic 322.

4. Hooking functions of target application 342 can be done in advance for example by changing target application 342 without the need to recompile source code associated therewith. In order to change the original application, the example process includes:
a. The code that should be injected into target application 342 is compiled to dex format using ANDROID™ SDK.
b. The resulted dex file is disassembled into smali (dalvik opcodes) using smali dissasembler.
c. The original application package is disassembled into smali (dalvik opcodes) using smali dissasembler.
d. The smali code from that should be injected is added into the application smali files.
e. All smali files are assembled to dex file using smali dissasembler.
f. AndroidManifest.xml decoded into readable format (text) using AxmlPrinter tool.
g. All needed permissions added to AndroidManifest.xml as needed.
h. New package is built using dex file and new updated AndroidManifest.xml using android sdk.
i. Package is signed with provided signature using jarsigner from ANDROID™ SDK.

5. In order to hook functions of target application 342, the following may be implemented:
a. All activity classes are modified to inherit from the injected ActivityEx class instead of ANDROID™ standard. The class is injected into the binary of target application 342 using the method described above.
b. Methods that need to be hooked are implemented in the custom ActivityEx class.
c. Once target application 342 calls super.method( ), the alternate methods will be called and custom logic can be implanted in the application code.

The code below demonstrates how Smali code is manipulated.

A sample target application:

```
.class public Lcom/exent/hello/hello;
.super Landroid/app/Activity;
.source “hello.java”
# direct methods
.method public constructor <init>( )V
  .registers 1
  .prologue
  .line 6
  invoke-direct {p0}, Landroid/app/Activity;-><init>( )V
  return-void
.end method
# virtual methods
.method public onCreate(Landroid/os/Bundle;)V
  .registers 3
  .parameter “savedInstanceState”
  .prologue
  .line 10
  invoke-super {p0, p1},
  Landroid/app/Activity;->onCreate(LAndroid/os/Bundle;)V
  .line 11
  const/high16 v0, 0x7f03
  invoke-virtual {p0, v0}, Lcom/exent/hello/hello;->setContentView(I)V
  .line 12
  return-void
.end method
```

The following is sample code that implements ActivityEx. This code is placed in the same folder to be compiled with the original sample application:

```
.class public Lcom/exent/inject/ActivityEx;
.super Landroid/app/Activity;
.source “ActivityEx.java”
# direct methods
.method public constructor <init>( )V
  .registers 1
  .prologue
  .line 6
  invoke-direct {p0}, Landroid/app/Activity;-><init>( )V
  return-void
.end method
# virtual methods <--------------------------------------- our onCreate( ) hook
.method public onCreate(Landroid/os/Bundle;)V
  .registers 3
  .parameter “savedInstanceState”
  .prologue
  .line 10
  invoke-super {p0, p1},
  Landroid/app/Activity;->onCreate(Landroid/os/Bundle;)V
  .line 11
  const/high16 v0, 0x7f03
  invoke-virtual {p0, v0},
  Lcom/exent/inject/ActivityEx;->setContentView(I)V
  .line 12
  return-void
.end method
```

This is the modified original application:

```
.class public Lcom/exent/hello/hello;
.super Lcom/exent/inject/ActivityEx;
.source “hello.java”
# direct methods
.method public constructor <init>( )V
  .registers 1
  .prologue
  .line 6
  invoke-direct {p0}, Lcom/exent/inject/ActivityEx;-><init>( )V
  return-void
.end method
# virtual methods
.method public onCreate(Landroid/os/Bundle;)V
  .registers 3
  .parameter “savedInstanceState”
  .prologue
  .line 10
  invoke-super {p0, p1}, Lcom/exent/inject/ActivityEx;-
>onCreate(Landroid/os/Bundle;)V
  .line 11
  const/high16 v0, 0x7f03
  invoke-virtual {p0, v0}, Lcom/exent/hello/hello;->setContentView(I)V
  .line 12
  return-void
.end method
```

As demonstrated, all references to Activity are changed to ActivityEx, which is implemented by the additional code. As a result, activity methods are intercepted and can be manipulated and additional code can be inserted into the original application.

It is important to mention that the same functionality can be achieved in other ways and this is only one example of a way to create an overlay cursor (or other visually-perceptible indicator) and to inject commands into an application in ANDROID™. One additional way to add code into an application, for example, is to provide an application programming interface (API) to the developer that implements the same Activity override and the application developer uses this class when he implements the application.

### IV. Saved Files Management

As discussed above, embodiments of the present invention enable applications designed exclusively for use on a touch-based mobile device (e.g., ANDROID™ applications) to be used on a television as well as on mobile devices such as smart phones.

Accordingly, it may be deemed desirable to allow users to utilize an application on a television and then maintain the state of that application so that the user can seamlessly continue to use the same application on a mobile device. For example, where the application is a video game, it may be desired to allow a user to play the video game on the television and then continue the same video game on a mobile device when he is on the road or otherwise outside his homes. The user's game play would ideally continue from the same place that he left off when playing on the television. Then, when the user returns home, he should be allowed to continue playing from the same point at which he left off on the mobile device.

Since, in this scenario, the same application is running on both devices, it is possible to add code to the application code that performs as follows:

1. When the game starts, check to see if there is save data on a network server for this user.
a. If there is a saved file, allow the user to download or automatically download the save data and place it in the appropriate storage location for the game.

2. When the game launches, the game uses the save data that is stored locally.

3. When the game ends, allow the user to upload or automatically upload the saved data to the network server.

4. Any time a device executes the application, follow the foregoing steps 1-3.

As demonstrated in the steps above, saved data is maintained and thus the user is allowed to continue game state from one device to the other. An additional advantage of the foregoing method is that it allows the user to backup his application data on a network server so if the user changes to a new device he can restore the save data of those applications that are backed up.

In order to distinguish between users, the first time a user uses this functionality on a device he may be required to authenticate. This way, multiple users can save data on the same server. Each user's data may be maintained, for example, in a designated folder according to the unique user ID. In addition, each application may have a unique ID. Thus, for each user, saved data per application is saved for example under a folder per application ID.

In addition, for each application, the user may opt to save history information on the server. Then, if the user would like to restore application data, he can select from different save points. For example, a folder may be created according to the date and time the save data was uploaded to the server.

In addition, in order to implement the foregoing, it may be required to identify where saved data is located for each application. In order to do that, the application may be executed in a test environment and a test engineer may search for the target folder or folders for the application. The obtained information may be maintained by the code that is added to the application. For example, such information may be stored in a configuration file.

Another option that may be used is to provide API functionality to the application developer such as: an API to upload the data to the server such as UploadData(UserId, AppId, RestorePoint, Data) and an API to restore the data such as DownloadData(UserId, AppId, RestorePoint, Data). Additional APIs can be provided such as EnumDataRestore that will return data about restore points to allow the user to select one.

### V. Example Processor-Based Computing System Implementation

The embodiments described herein, including systems, methods/processes, and/or apparatuses, may be implemented using a processor-based computing system, such as a system 1000 shown in FIG. 10. For example, remote control device 302 and viewing device 304 described above in reference to FIG. 3 may be implemented using system 1000. Furthermore any of the method steps described in reference to the flowcharts of FIGS. 4-7 may be implemented by software modules executed on system 1000.

System 1000 can represent any commercially-available and well-known processor-based computing system or device capable of performing the functions described herein. System 1000 may comprise, for example, and without limitation, a desktop computer system, a laptop computer, a tablet computer, a smart phone or other mobile device with processor-based computing capabilities.

System 1000 includes a processing unit 1004. In one embodiment, processing unit 1004 comprises one or more processors or processor cores. Processing unit 1004 is connected to a communication infrastructure 1002, such as a communication bus. In some embodiments, processing unit 1004 can simultaneously operate multiple computing threads.

System 1000 also includes a primary or main memory 1006, such as random access memory (RAM). Main memory 1006 has stored therein control logic 1028A (computer software), and data.

System 1000 also includes one or more secondary storage devices 1010. Secondary storage devices 1010 include, for example, a hard disk drive 1012 and/or a removable storage device or drive 1014, as well as other types of storage devices, such as memory cards and memory sticks. For instance, computer 1000 may include an industry standard interface, such a universal serial bus (USB) interface for interfacing with devices such as a memory stick. Removable storage drive 1014 represents a floppy disk drive, a magnetic tape drive, a compact disk drive, an optical storage device, tape backup, etc.

Removable storage drive 1014 interacts with a removable storage unit 1016. Removable storage unit 1016 includes a computer useable or readable storage medium 1024 having stored therein computer software 1028B (control logic) and/or data. Removable storage unit 1016 represents a floppy disk, magnetic tape, compact disk, DVD, optical storage disk, or any other computer data storage device. Removable storage drive 1014 reads from and/or writes to removable storage unit 1016 in a well known manner.

System 1000 also includes input/output/display devices 1022, such as displays, keyboards, pointing devices, touch screens, etc.

System 1000 further includes a communication or network interface 1018. Communication interface 1018 enables system 1000 to communicate with remote devices. For example, communication interface 1018 allows system 1000 to communicate over communication networks or mediums 1042 (representing a form of a computer useable or readable medium), such as LANs, WANs, the Internet, etc. Communication interface 1018 may interface with remote sites or networks via wired or wireless connections.

Control logic 1028C may be transmitted to and from computer 1000 via communication medium 1042.

Any apparatus or manufacture comprising a computer useable or readable medium having control logic (software) stored therein is referred to herein as a computer program product or program storage device. This includes, but is not limited to, system 1000, main memory 1006, secondary storage devices 1010, and removable storage unit 1016. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for performing, for example, any of the steps described above in the flowcharts of FIGS. 4-7 and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### VI. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for remotely controlling a target application executing on a display device, the target application being configured to perform operations in response to a predefined set of commands, wherein at least one of the operations comprises rendering graphical content to a display of the display device, the method comprising:
receiving user input events generated in response to interaction by a user with a touch-based user input component of a remote control device;
converting the user input events into commands from the predefined set of commands; and
injecting the commands into the target application executing on the display device, thereby causing the target application to perform operations corresponding to the injected commands;
wherein the injecting step is performed by a processing unit of the display device responsive to executing a software module that is not part of original source code associated with the target application.

2. The method of claim 1, wherein the converting step is performed by one of:
the remote control device;
the display device; or
a third device that is not the remote control device or the display device.

3. The method of claim 1, further comprising:
identifying a location of a hotspot on the display; and
providing a visual indication of the hotspot location on the display.

4. The method of claim 3, further comprising:
changing the hotspot location based on one or more of the user input events; and
moving the visual indication of the hotspot location on the display in response to the changing step.

5. The method of claim 3, wherein converting the user input events into commands comprises converting one or more of the user input events into a tap command at the hotspot location.

6. The method of claim 5, wherein converting the user input events into the tap command at the hotspot location comprises converting user input events generated when the user has a first finger placed at a first location on a surface of the touch-based user input component and taps a second location on the surface of the touch-based user input component with a second finger.

7. The method of claim 5, wherein converting the user input events into the tap command at the hotspot location comprises converting user input events generated when the user taps a tap area on the surface of the touch-based user input component.

8. The method of claim 5, wherein converting the user input events into the tap command at the hotspot location comprises converting user input events generated when the user taps anywhere on the surface of the touch-based user input component.

9. The method of claim 3, wherein converting the user input events into commands comprises converting one or more of the user input events into a drag command that is initiated at the hotspot location.

10. The method of claim 9, wherein converting the user input events into the drag command that is initiated at the hotspot location comprises converting user input events generated when the user has a first finger placed at a first location on a surface of the touch-based user input component and drags a second finger across the surface of the touch-based user input component.

11. The method of claim 9, wherein converting the user input events into the drag command that is initiated at the hotspot location comprises converting user input events generated when the user drags a finger across a surface of the touch-based user input component after tapping a drag area on the surface of the touch-based user input component.

12. The method of claim 1, wherein converting the user input events into commands comprising converting one or more of the user input events into a zoom in or zoom out command.

13. A system, comprising:
a display device that includes a first processing unit and a display, the first processing unit being operable to execute a target application that performs operations in response to a predefined set of commands, wherein at least one of the operations comprises rendering graphical content to the display; and
a remote control device that includes a second processing unit and a touch-based user input component, the second processing unit being operable to execute remote control logic that captures user input events generated when a user interacts with the touch-based user input component and that transmits the user input events to the display device via a network;
the first processing unit of the display device being further operable to execute controller logic and injection logic that are not part of original source code of the target application, the controller logic generating commands from the predefined set of commands based on the user input events received from the remote control device and the injection logic injecting the commands generated by the controller logic into the target application, thereby enabling the user to remotely control the performance of the operations of the target application.

14. The system of claim 13 wherein the controller logic identifies a location of a hotspot on the display and wherein the first processing unit of the display device is further operable to execute overlay logic that provides a visual indication of the hotspot location on the display.

15. The system of claim 13, wherein the controller logic changes the hotspot location based on one or more of the user input events received from the remote control device and causes the overlay logic to move the visual indication of the hotspot location accordingly.

16. The system of claim 14, wherein the controller logic generates a tap command at the hotspot location based on the user input events received from the remote control device.

17. The system of claim 16, wherein the controller logic generates the tap command at the hotspot location by converting user input events generated when the user has a first finger placed at a first location on a surface of the touch-based user input component and taps a second location on the surface of the touch-based user input component with a second finger

18. The system of claim 16, wherein the controller logic generates the tap command at the hotspot location by converting user input events generated when the user taps a tap area on the surface of the touch-based user input component.

19. The system of claim 14, wherein the controller generates a drag command that is initiated at the hotspot location based on the user input events received from the remote control device.

20. The system of claim 19, wherein the controller generates the drag command that is initiated at the hotspot location by converting user input events generated when the user has a first finger placed at a first location on a surface of the touch-based user input component and drags a second finger across the surface of the touch-based user input component.

21. The system of claim 19, wherein the controller generates the drag command that is initiated at the hotspot location by converting user input events generated when the user drags a finger across a surface of the touch-based user input component after tapping a drag area on the surface of the touch-based user input component.

22. The system of claim 19, wherein the drag command that is generated is one of two drag commands that together comprise a zoom command.

23. The system of claim 13, wherein the display device does not include a touch-based user input component but the target application is configured to perform the operations in response to commands generated based on user interaction with a touch-based user input component.

24. A computer program product comprising a computer-readable storage medium having computer program logic recorded thereon for enabling a processing unit to facilitate remote control of a target application executing on a display device, the target application being configured to perform operations in response to a predefined set of commands, wherein at least one of the operations comprises rendering graphical content to a display of the display device, the computer program logic comprising:
first computer program logic that, when executed by the processing unit, receives user input events generated in response to interaction by a user with a touch-based user input component of a remote control device;
second computer program logic that, when executed by the processing unit, converts the user input events into commands from the predefined set of commands; and
third computer program logic that, when executed by the processing unit, injects the commands into the target application executing on the display device, thereby causing the target application to perform operations corresponding to the injected commands;
wherein the first, second and third computer program logic are not part of original source code associated with the target application.
